(19) United States
(12) Patent Application Publication
(10) Pub. No.: US 2009/0101878 A1
(43) Pub. Date: Apr. 23, 2009

(54) Closing Part and Gate Provided with Such a Closing Part

(76) Inventors: Jan Rudolf Ruigrok, Eindhoven (NL); Willem Arie Theume, Waalwijk (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/212,542

(22) Filed: Sep. 17, 2008

(30) Foreign Application Priority Data
Sep. 25, 2007 (NL) NL2000880

(51) Int. Cl. E06B 11/02; E05C 5/04

(52) U.S. Cl. 256/73; 292/251

(57) ABSTRACT

Closing part for a gate, comprising an elongate horizontal lower girder and upper girder and a closing material which lies substantially in one plane therebetween and which is connected on one side to the lower girder and on the other side to the upper girder, wherein the closing material is tensionable and supports are arranged between the upper and lower girders, which supports are provided with tensioning means, this such that the closing material is tensionable between the upper girder and the lower girder.

The present invention relates to a closing part according to the preamble of claim 1.

Such a closing part, typically intended for a sliding gate, is described in for instance NL 1024939 in the name of applicant. This patent describes a gate with a closing part which is mounted slidably relative to a number of portal-like support elements. The closing part has a lower beam-like profile piece and a toothed upper edge between which extend bars. EP 0 128 248 and EP 0 738 822, likewise in the name of applicant, further describe other embodiments of sliding gates.

In the existing constructions a large number of bars is generally required in order to obtain a gate with sufficient rigidity. In addition, the existing sliding gates are generally rather heavy.

The present invention has for its object to provide a closing part as described in the introduction which is simple to mount and forms a light construction with sufficient rigidity.

The invention is distinguished for this purpose by the characteristic of claim 1.

By tensioning the closing material between the upper and lower girders using the supports the upper girder also acquires a supporting function and one rigid closing part is obtained which is light, compared to the closing parts of the prior art sliding gates, because of the use of a relatively light closing material instead of for instance non-tensioned bars.

The phrase “closing material which lies substantially in one plane”, also referred to below as surface filling, must be interpreted broadly and typically designates any type of closing material which is suitable for tensioning between two girders and thus imparts extra rigidity and stability to the closing part. Typically envisaged here are wire mesh, gauze mesh, expanded metal, plates, a group of bars arranged mutually adjacently, and the like. The term “support” must also be interpreted broadly and typically designates struts and any other type of supporting element.

Advantageous embodiments are described in the dependent claims 2-9.

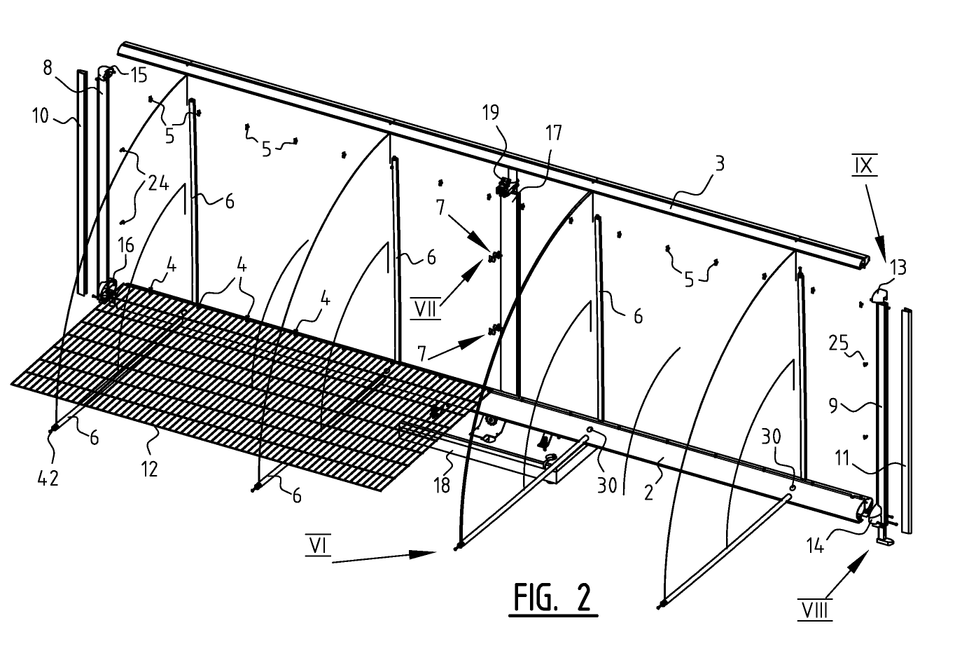

A possible embodiment suitable for a wire mesh has the characteristic of claim 5. Advantages hereof are stated below with reference to the exemplary embodiment of FIGS. 2-5. In the case of a plate-like closing material or an expanded metal, simple nut-bolt constructions can for instance be used for this connection.

Each support is preferably provided on at least one end with a threaded bore into which a pressure bolt, also referred to as tensioning bolt or levelling screw, is rotated in each case. The supports are mounted such that the pressure bolt supports against the upper or lower girder. In this way the distance between the upper and lower girders can be adjusted by rotating the bolt to a suitable height into/out of the threaded bore.

In a still further developed embodiment the horizontal girder against which the pressure bolts press are provided with holes which are localized and dimensioned such that the bolts are accessible for a suitable tool with which the bolt can be rotated into/out of the threaded bore.

The lower and upper beams are typically profile pieces which can advantageously be equipped with one or more fixing flanges and/or channels for the purpose of connecting the closing material to the upper and lower girders. The upper and lower girders are further preferably provided with recesses for arranging of the supports therein.

According to a possible embodiment, the closing material is mounted centrally between upper and lower girder, wherein a series of supports is provided on either side of this material. A symmetrical construction with a good distribution of forces is in this way obtained. The supports preferably run toward each other on opposite sides of the closing material in order to increase the stability of the construction.

Finally, the invention relates to a sliding or swing gate comprising a closing element.

The invention will be further elucidated hereinbelow on the basis of a non-limitative exemplary embodiment with reference to the accompanying drawings. The exemplary embodiment is purely illustrative and not intended to limit the scope of protection. In the drawing:

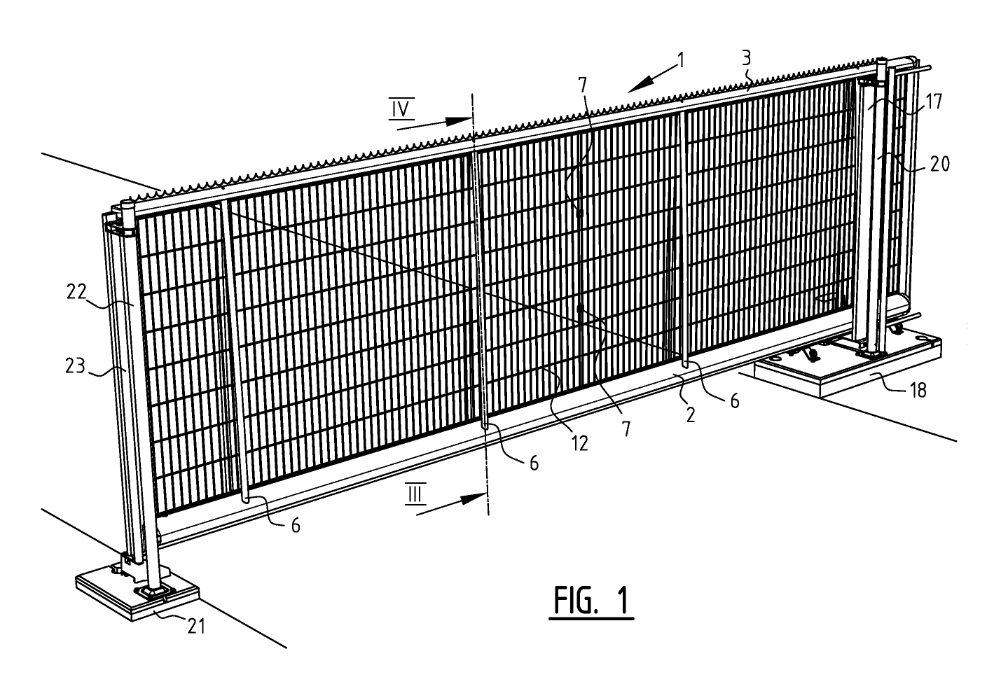

FIG. 1 is a perspective view of a sliding gate according to a first embodiment of the invention;

FIG. 2 shows the assembly of the sliding gate of FIG. 1;

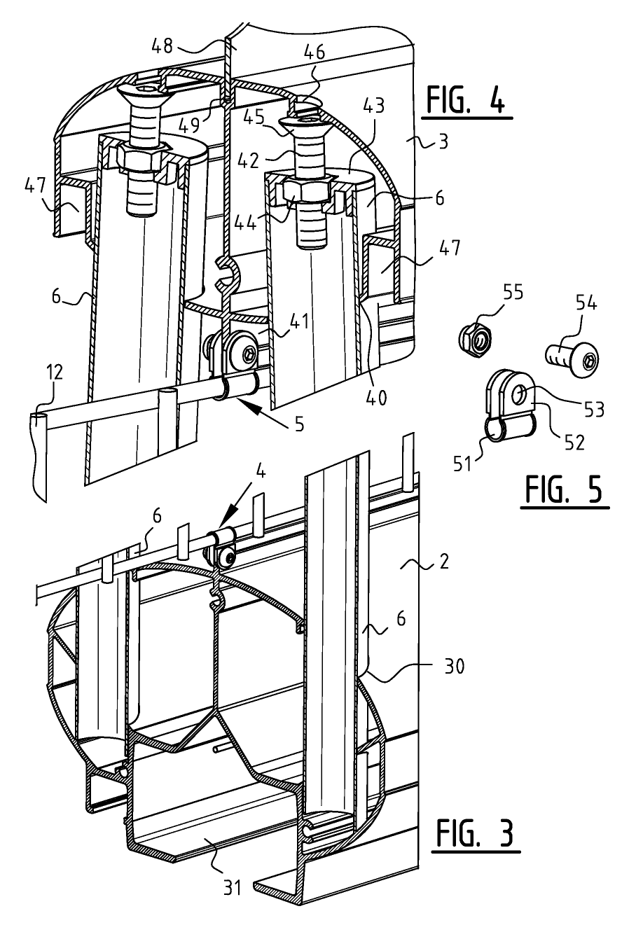

FIG. 3 shows a part-sectional view along line III in FIG. 1;

FIG. 4 shows a part-sectional view along line IV in FIG. 1;

FIG. 5 shows a detail view of the clamping means 4, 5 of FIGS. 3 and 4; and

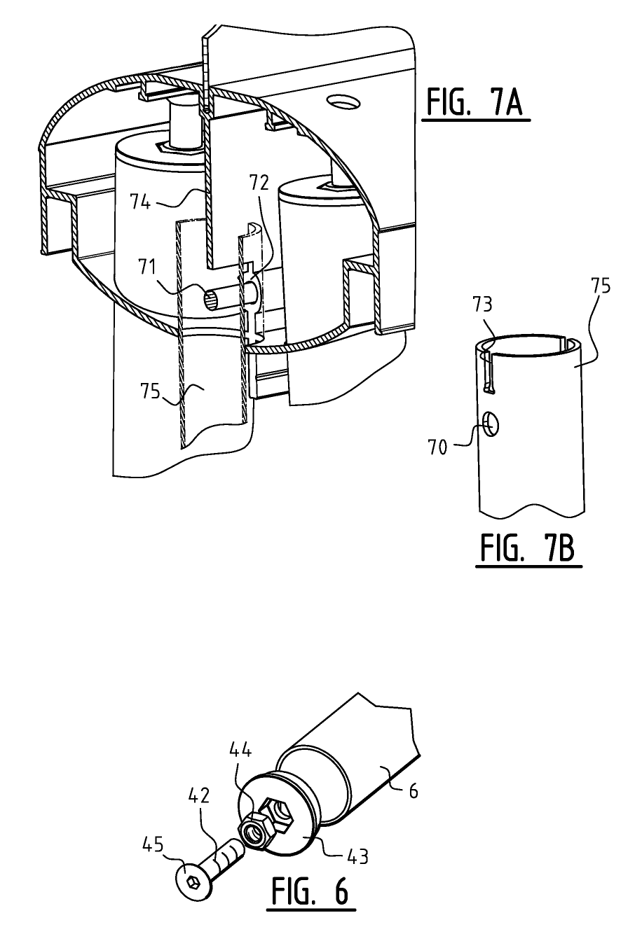

FIG. 6 is a perspective view of the outer end of a support 6;

FIG. 7 is a partially perspective view of a second embodiment of a closing part according to the invention.

FIG. 1 shows an embodiment of a sliding gate 1 for closing a passageway. The sliding gate comprises at least a number of support elements 17, 18, 19, 20, 21, 22, 23 and a closing part mounted slidably relative to these support elements. The closing part is constructed substantially from a lower beam-like profile piece 2, referred to below as lower girder 2, an upper beam-like profile piece 3 with a toothed upper edge, referred to below as upper girder 3, a number of struts 6 placed therebetween, and a wire mesh 12 tensioned between the upper and lower girders.

In order to provide a better insight into the construction of the closing part the assembly thereof will now be illustrated with reference to FIG. 2. In a first step the lower horizontal wire of a wire mesh 12 is connected to lower girder 2 by means of clamping means 4. The clamping means will be discussed in detail with reference to FIGS. 3-5 and are adapted such that wire mesh 12 can pivot relative to lower girder 2. FIG. 1 shows only one wire mesh 12, although the skilled person will appreciate that a second wire mesh 12 can be attached in the same manner to lower girder 2 adjacently of the drawn wire mesh 12. These wire meshes are then brought into a vertical position together with a first series of struts 6 located on a first side of wire meshes 12. The struts on the other side of wire meshes 12 are already situated in substantially vertical position in girder 2. The two wire meshes 12 are subsequently connected to each other by means of connecting means 7.

Note that in the case of a different surface filling, such as for instance a plate material, this can also be directly mounted vertically, for instance in a U-profile specially provided for this purpose in the lower girder.

Once wire meshes 12 and struts 6 have been placed in the standing position, upper girder 3 is arranged, wherein struts 6 are placed through openings 40 in upper girder 3. The uppermost horizontal wire of wire meshes 12 is subsequently connected by means of clamping means 5 to a central flange extending along the length of upper girder 3. Using these pressure bolts 42 (see FIG. 4) the distance between upper and lower girders 2, 3 can be increased in order to thus bring the meshes into a tensioned state. Note that supports 6 stand at a slight angle, whereby the stability is further improved.

Finally, the vertical end parts 8, 9, 10, 11 are mounted against the outer ends of the closing part, wherein end plates 13-16 form a transition between the girders and the vertical end parts. These end parts can then be connected by means of clamping means 24, 25 to the outermost vertical wires of wire meshes 12.

Upper girder 3 is further provided with a longitudinal slot in which a guide 19, which can be connected to the upper end of support elements 17, 23, is movable for the purpose of guiding the closing part along the support elements during opening/closing of the gate. Lower girder 2 is also provided with an elongate channel 31 (see FIG. 3) which extends over the full length of lower girder 2 and in which a wheel construction is typically arranged for the purpose of guiding lower girder 2. The support and guide system of the sliding gate does not however form part of the present invention.

An embodiment of the levelling means for struts 6 will now be elucidated. FIG. 4 shows how struts 6, which extend on either side of wire mesh 12, protrude through openings 40 in upper girder 3. Struts 6 are closed at their upper end with a pressure piece 43 in which a nut 44 is arranged. The nut co-acts with a pressure bolt 42 with a head 45. This head 45 is accessible from outside through openings 46 in the top side of upper girder 3. The pressure bolt can be rotated upward/downward through these openings using an appropriate tool (see also FIG. 6) for the purpose of moving upper girder 3 upward/downward relative to lower girder 2.

It can further be seen in FIG. 4 that the toothed upper edge of the closing part is constructed from toothed plate elements 48 pressed into a groove 49 of the upper girder. In this way a clamping fit is obtained between toothed plate elements 48 and the upper girder.

The upper horizontal wire of steel mesh 12 is attached by means of a number of clamps 5, one of which is shown in FIG. 4, to a central downward directed flange 41 of upper girder 3. Clamping means 5 is shown in detail in FIG. 5 and consists of a bracket-like element 51 with two legs 52, each with an opening 53 for a bolt-nut assembly 54, 55.

Upper girder 3 is further provided on each of its sides with a longitudinal channel 47 in which a slide element (not shown) can be arranged for the purpose of guiding upper girder 3 along the support elements.

As shown in FIG. 3, lower girder 2 is likewise provided with openings 30 for the purpose of arranging struts 6 therein. In the shown embodiment struts 6 are provided at a top end with pressure bolts, although the skilled person will appreciate that an equivalent embodiment is possible in which the pressure bolts are provided at the bottom end or at both the bottom and top end. The lower horizontal wire of wire mesh 12 is connected by means of identical clamping means 4 to a central vertical flange provided on the top side of lower girder 2.

Finally, FIG. 7 shows a second variant in which bars are used as closing material. Arranged at the outer ends of these bars are two diametrically opposite holes 70 for a horizontal threading wire 71 which is further guided in a channel 72 of upper/lower girder 32 for the purpose of realizing the connection thereto. The bars can be provided at their outer ends with slots 73 for receiving therein a flange 74 of the upper/lower girder in order to simplify positioning of the holes for the threading wire.

The skilled person will appreciate the many other fixing techniques can be used to fix the bars to upper and lower girders, such as snap systems, screw systems, deforming systems (such as expanding of the bars) etc.

It is further noted that many variants of the levelling means are also possible. The supports could thus be embodied in the form of telescopic tubes etc.

The invention is not limited to the above described embodiment variants, and the skilled person will appreciate that many modifications and variants are possible without departing from the scope of the invention, which is defined solely by the appended claims.

1. Closing part for a gate, comprising:
an elongate horizontal lower girder and upper girder;
and a closing material which lies substantially in one plane therebetween and which is connected on one side to the lower girder and on the other side to the upper girder;
wherein the closing material is tensionable;
and wherein supports are arranged between the upper and lower girders, said supports being provided with tensioning means, this such that the closing material is tensionable between the upper girder and the lower girder.

2. Closing part as claimed in claim 1, wherein the tensioning means are levelling means for adjusting the distance between the lower girder and the upper girder.

3. Closing part as claimed in claim 2, wherein the levelling means for each support comprise a pressure bolt with corresponding threaded bore, said threaded bore with pressure bolt being provided at an end of a support, said pressure bolt presses in the assembled situation against one of said horizontal girders.

4. Closing part as claimed in claim 1, wherein the closing material is a material from the following group of:
mesh (wire mesh, gauze mesh etc.), a set of bars arranged adjacently of each other, a plate material, an expanded metal.

5. Closing part as claimed in claim 2, wherein the closing material is a material from the following group of:
mesh (wire mesh, gauze mesh etc.), a set of bars arranged adjacently of each other, a plate material, an expanded metal.

6. Closing part as claimed in claim 4, wherein the closing material is a wire mesh, wherein respectively the lower and upper wire of the wire mesh are connected by means of bracket-like elements to respectively the lower girder and the upper girder.

7. Closing part as claimed in claim 4, wherein the closing material consists of a set of vertical bars, wherein the bars are connected to respectively the upper girder and lower girder, in each case by means of a horizontal threaded wire through the top end of the bars and through a horizontal channel in respectively the upper girder and lower girder.

8. Closing part as claimed in claim 3, wherein the horizontal girder against which the pressure bolts support is provided with holes at the position of the pressure bolts such that these latter are accessible for a suitable tool.

9. Closing part as claimed in claim 1, wherein the lower girder and the upper girder are profile pieces.

10. Closing part as claimed in claim 1, wherein the lower girder and the upper girder are provided with recesses for placing of the supports therein.

11. Closing part as claimed in claim 2, wherein the lower girder and the upper girder are provided with recesses for placing of the supports therein.

12. Closing part as claimed in claim 1, wherein the lower girder and upper girder are connected to the closing material at a number of points located a pitch distance from each other, and wherein a series of supports is provided on either sides of this closing material.

13. Closing part as claimed in claim 1, wherein the supports are provided at either side of the closing material, and wherein the supports, as seen from bottom to top, run at a slight angle in the direction of the plane of the closing material, and preferably make an angle to the vertical of between 0° and 30°, more preferably between 0° and 15°.

14. Gate comprising at least one support element and a closing part comprising
an elongate horizontal lower girder and upper girder; and
a closing material which lies substantially in one plane therebetween and which is connected on one side to the lower girder and on the other side to the upper girder;
wherein the closing material is tensionable;
and wherein supports are arranged between the upper and lower girders, said supports being provided with tensioning means, this such that the closing material is tensionable between the upper girder and the lower girder, said closing part being mounted slidably or rotatably relative to this support element.

15. Closing part for a gate, comprising:
an elongate horizontal lower girder and upper girder;
and a closing material which lies substantially in one plane therebetween and which is connected on one side to the lower girder and on the other side to the upper girder;
wherein the closing material is tensionable; and wherein a series of struts are arranged between the upper and lower girders, each strut being provided with a pressure piece with a threaded bore cooperating with a bolt, for adjusting the distance between the lower girder and the upper girder.

16. Closing part as claimed in claim 15, wherein the closing material is a material from the following group of:
mesh (wire mesh, gauze mesh etc.), a set of bars arranged adjacently of each other, a plate material, an expanded metal.

17. Closing part as claimed in claim 15, wherein the closing material is a material from the following group of:
mesh (wire mesh, gauze mesh etc.), a set of bars arranged adjacently of each other, a plate material, an expanded metal.

18. Closing part as claimed in claim 17, wherein the closing material is a wire mesh, wherein respectively the lower and upper wire of the wire mesh are connected by means of bracket-like elements to respectively the lower girder and the upper girder.

19. Closing part as claimed in claim 17, wherein the closing material consists of a set of vertical bars, wherein the bars are connected to respectively the upper girder and lower girder, in each case by means of a horizontal threaded wire through the top end of the bars and through a horizontal channel in respectively the upper girder and lower girder.

20. Closing part as claimed in claim 15, wherein the horizontal girder against which the pressure bolts support is provided with holes at the position of the pressure bolts such that these latter are accessible for a suitable tool.
